(19) United States
(12) Patent Application Publication
(10) Pub. No.: US 2009/0313101 A1
(43) Pub. Date: Dec. 17, 2009

(54) PROCESSING RECEIPT RECEIVED IN SET OF COMMUNICATIONS

(75) Inventors: Sean Michael McKenna, Seattle, WA (US); Stuart Henry Seelye Marshall, Seattle, WA (US); Bradley Ward, Seattle, WA (US); Arun K. Sacheti, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/138,430

(22) Filed: Jun. 13, 2008

(51) Int. Cl. G06Q 10/00; G06Q 30/00

(52) U.S. Cl. 705/14.25; 705/10; 705/30

(57) ABSTRACT

Receipts may be received at a location that a customer normally uses to receive electronic correspondence, such as an e-mail address, an instant messaging address, etc. Among the items that are sent to that location, those items that contain a receipt may be identified. The identified receipts, or information extracted from such receipts, may be sent to a receipt store. An action, such as displaying the receipts to a customer, may be taken based on content stored in the receipt store. The information that is stored in a receipt store and/or that is displayed to customers may have an arbitrary level of detail.

### CROSS-REFERENCE TO RELATED CASES

This application is related to the commonly-assigned U.S. patent application filed under Docket No. 323555.01 and entitled “Handling Payment Receipts with a Receipt Store,” filed on the same date as the present application.

### BACKGROUND

A receipt is typically generated as a consequence of a commercial transaction, such as a sale, a lease, a rental, a hotel stay, etc., or a non-commercial transaction such as a charitable donation. Traditionally, these receipts have been created on paper. With the advent of e-commerce, many transactions have generated receipts in electronic form. Typically, as part of an e-commerce transaction, a participant in the transaction enters an e-mail address, or enters an account name that has previously been associated with the participant's e-mail address. The electronic receipt is then sent to the e-mail address associated with the transaction. The practice of sending a receipt to an e-mail address has been used with various kinds of transactions, such as on-line retail purchases, car rentals, hotel stays, and various other kinds of transactions.

When receipts are sent to e-mail addresses, they tend to collect in the recipient's mailbox, mixed in with the recipient's general incoming correspondence. In some cases, rules or filters could be used to identify a receipt and to move the receipt to a specific folder. However, even if the receipts were segregated from the regular mail stream in this way, the receipts would still be in the form of an e-mail, and would be accessible only in the normal way that e-mails are accessible—e.g., by opening and viewing the e-mail item.

### SUMMARY

E-mails that contain receipts may be identified, so that the content of the receipt may be extracted and stored in a receipt store. A component may be used to identify e-mails that contain receipts. The component could separate receipt e-mails from other e-mails. The component could extract certain types of information from the receipt and could store the information in a receipt store. Or, the component could send the e-mail receipt to the receipt store, which could then extract the information from the e-mail receipt. The component that identifies e-mail receipts and/or extracts information from those receipts could work with a web-based e-mail service, an e-mail client program, an e-mail server program, or any other type of e-mail system. As one example, the component could be implemented as a plug-in that works with e-mail client software.

The extracted information might include the name of the vendor, the item(s) purchased, the amount for which they are purchased, coupons, advertisements, event announcements, point balances, or any other kind of information. The extracted content could then be placed in a structured form, which could be stored in a receipt store. Or, the receipt store could store the e-mail containing the receipt rather than storing extracted information. The receipt store may give a customer access to his or her receipts, including whatever detailed information is contained in the receipt. The receipts store may also provide other types of services, such as enabling customers to share information about their purchases with other people, mining information about a customer's purchase habits from that customer's receipts, marshalling purchase information for use with money management software, or any other type of service that could be performed using the information collected from receipts. The receipt store could use the information in a receipt to connect a participant in a transaction to any post purchase scenario, such as obtaining manuals for products purchased, upselling or cross-selling opportunities, on-line community of users of a product that has been purchased, rating the product or merchant, or any other scenario.

The recognition of receipts and/or extraction of information from those receipts could be performed in a variety of ways. For example, parsers could be written to recognize receipts of large retailers and/or to extract information from those receipts. Or, general pattern-recognition techniques could be used to identify e-mails that contain receipts and/or to extract information from those e-mails. Moreover, since commercial entities may find it beneficial to have their receipts recognized and to have the information contained in their receipts correctly extracted, such commercial entities could develop recognition software and/or templates for the receipts they issue. Receipt store providers could use the software and/or templates in order to identify, and/or extract information from, receipts issued by that entity.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example system in which a receipt may be generated and placed in a receipt store.

FIG. 2 is a block diagram of an example receipt.

FIG. 3 is a flow diagram of an example process in which a receipt may be received and may be sent to a receipt store.

FIG. 4 is a block diagram of example components that may be used in connection with implementations of the subject matter described herein.

### DETAILED DESCRIPTION

Electronic receipts are traditionally delivered in the form of e-mail. E-mail receipts may be more convenient than paper receipts. However, when receipts are e-mailed, they tend to collect in the customer's inbox along with the general stream of correspondence. The same would also occur if receipt are delivered using other electronic delivery mechanisms, such as instant messaging (IM), short message service (SMS), etc. Instead of collecting in an inbox, receipts could be stored in a receipt store, where the receipts could be made accessible to customers, or could be used in a variety of ways. Mechanisms described herein may be used, for example, to send receipts to a receipt store and/or to take various actions based on the receipts in the receipt store. The examples herein describe receipts being sent to e-mail addresses. However, the example of e-mail, as described below, may also be applied to receipts that are sent in other forms (such as IM, SMS, etc.), and the subject matter described herein applies to any such form. Moreover, the electronic receipts mentioned herein could take any form, such as text, images, audio, video, etc.

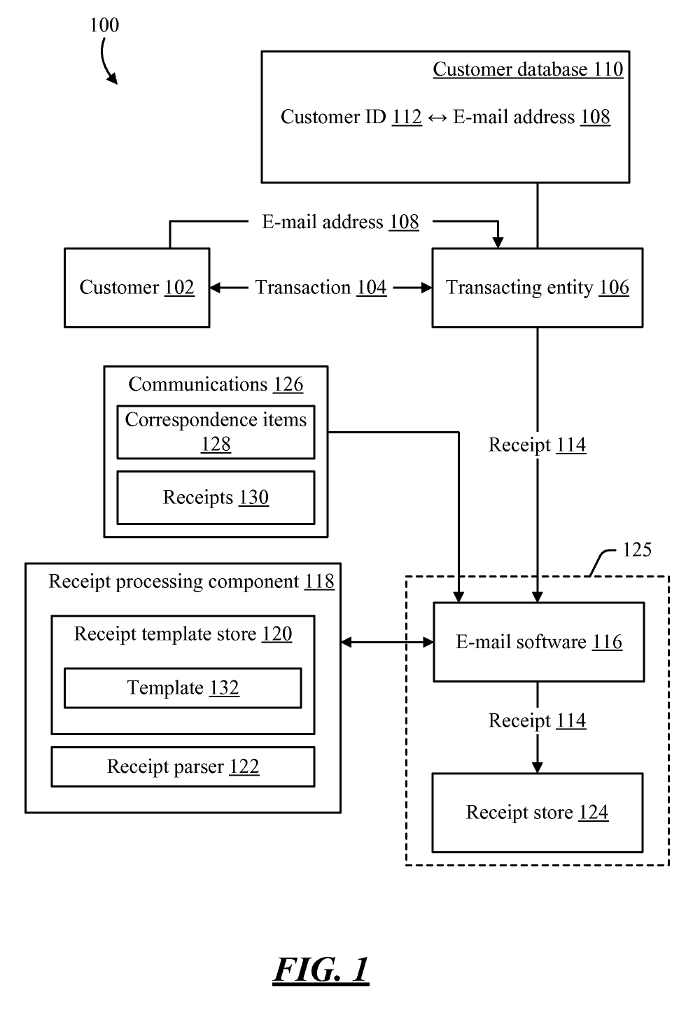

Turning now to the drawings, FIG. 1 shows an example system 100 in which a receipt may be generated and placed in a receipt store. Customer 102 engages in a transaction 104 with transacting entity 106. Typically, customer 102 is a person, although customer 102 could be any type of entity, such as a business, a university, a non-profit organization, or any other type of entity that can engage in a transaction. Moreover, transaction 104 could be any type of transaction, such as a purchase, a lease, a rental, a travel reservation, a donation to charity, etc. Transacting entity 106 could be any type of entity, such as a store, an airline, a charity that is receiving a donation, etc. In short, any type of transaction could be performed, and the transaction could involve any kind of customer and any kind of transacting entity.

As part of engaging in transaction 104, customer 102 may provide e-mail address 108 to transacting entity 106. For example, customer 102 may provide e-mail address 108 at the time that transaction 104 occurs. As another example, transacting entity 106 may retrieve e-mail address 108 from customer database 110, which associates customer 102's customer identifier 112 with e-mail address 108. For example, transacting entity 106 may maintain a database of its existing customers. As another example, there may be a third-party service that associates e-mail addresses (and possibly other information) with user identifiers.

A WINDOWS LIVE identifier, a Google account name, and a Yahoo account name are some examples of identifiers that could be associated with an e-mail address and could be used by various transacting entities. Customer database 110 might also store credit card numbers, house account balances, gift certificates, a shipping address, or any other type of information that could be used as part of transaction 104.

When transaction 104 has been performed, transacting entity 106 may generate receipt 114. Receipt 114 may be sent to an e-mail address 108 (or other delivery channel). The e-mail address (or other channel) may be one that is associated with the transaction, although the receipt could be sent to any delivery channel. Receipt 114 may be received by e-mail software 116, which may take various forms. For example, e-mail software 116 may comprise any combination of the following: server software at customer 102's mail host; a local e-mail client; a web-based e-mail application; mobile e-mail server or client software; or any other type of software.

E-mail software 116 may comprise, or otherwise make use of, receipt processing component 118. Receipt processing component 118 evaluates a set of one or more communications 126 (e.g., incoming e-mails, incoming SMS messages, etc.) to determine which items among communications 126 appear to be, or contain, receipts. A set of communications 126 may contain correspondence items 128 and/or receipts 130, and receipt processing component 118 may distinguish between these kinds of items (although a single item could contain both receipts and correspondence, so the receipt/correspondence distinction is not an either/or proposition). (The following discussion assumes that the communications are in the form of e-mails handled by e-mail software, although it will be understood that incoming communications could take any form, such as IM, SMS, etc., and could be handled by the software appropriate for that type of communication.) Receipt processing component 118 may take the form of software that is part of e-mail software 116, or that otherwise communicates with e-mail software 116. Receipt processing component could operate at any location that handles customer 102's incoming mail, such as at a mail hosting server, a desktop mail client, a mobile client, a webmail application, or any other location. For example, receipt processing component 118 might be a plug-in or add-on that works with a desktop e-mail client application that receives e-mail to be viewed by a person. Examples of such e-mail client applications include the MICROSOFT OUTLOOK EXPRESS application, the MOZILLA THUNDERBIRD application, and any other e-mail client. As another example, receipt processing component 118 could be software that works with a mail server, or could be an application that runs on a mobile e-mail device. As a further example, receipt processing component 118 could be an integral part of an e-mail program (regardless of whether that e-mail program is a server program, a client program, a web application, etc.). As yet another example, the transacting entity, or an entity working on the transacting entity's behalf, could process a receipt and put the content of the receipt into a structured form to be delivered to the customer as an e-mail, SMS, IM, etc. Moreover such an entity could also process the receipt to extract information to be sent to a receipt store, while also allowing the original receipt to be sent to the customer's e-mail address, SMS address, IM address, etc.

Receipt processing component 118 may comprise, or otherwise use, receipt template store 120 and/or receipt parser 122 to assist in recognizing receipts in an incoming e-mail stream. For example, receipts generated by large retailers might have well-known receipt formats, and a template 132 for that format could be stored in receipt template store 120. The template could take the form of program code that, when executed, identifies an e-mail containing a particular receipt and extracts particular fields of information from the receipt (such as items purchased, prices paid, etc.). As another example, the information used to recognize the receipt could be (non-code) data that describes the structure of the receipt. A communication (e.g., an e-mail) could be compared to a template to determine a level of similarity between the communication and the template; if the similarity level exceeds some threshold, then the communication could be identified as containing a receipt. The template might be provided by the issuer of the receipt, in order to assist receipt processing component 118 in recognizing that provider's receipts. For example, a large electronics retailer may have an interest in having its receipts correctly recognized in an e-mail stream, and thus may provide a template that facilitates correct recognition of that retailer's receipts (although templates could be provided by any party, including, but not limited to, the customer). Templates could also be created that describe common formats used by smaller, less-well-known retailers. In general, a receipt template may be descriptive of a class of receipts and may be used to recognize that class. In this case, the class could encompass receipts issued by a particular retailer, receipts that meet particular format specifications, or any other type of class.

Receipt parser 122 may be used to identify receipts based on their content. For example, even if a receipt has no associated template in receipt template store 120, the e-mail containing the receipt might contain certain keywords, such as “receipt”, “payment”, “items”, “quantity”, etc. Such words may tend to indicate that an e-mail containing these words is a receipt. Moreover, the meaning of certain data in a receipt could be inferred from the proximity of these words to the data, or from other contextual cues. (E.g., receipt parser 122 may recognize that when the word “total” is followed by a dollar-sign, the next number that appears is the total amount paid.) Receipt parser 122 and/or receipt template store 120 may help receipt processing component 118 to recognize receipts in an incoming e-mail stream, although receipt processing component 118 could recognize receipts in any manner. Parsing could be done wholly by machine, or it could be done partially by machine and supplemented by humans. For example, an e-mail that had been parsed could be presented to a human (such as the transacting entity, the customer, or another party) so that the result of the parsing could be verified or corrected.

The particular keywords or other cues that receipt parser 122 uses to recognize and obtain information from receipts could be chosen in any manner. For example, keywords and other cues that are indicative of a receipt could be identified by human analysis and could be hard-coded into receipt parser 122. As another example, the keywords and other cues could be discovered using machine-learning techniques, such as by providing a set of example receipts as input to a machine-learning algorithm.

When a receipt 114 has been identified in an e-mail stream or store (e.g., using receipt processing component 118, or some other mechanism), that receipt may be directed to receipt store 124. Receipt store 124 could be a store that exists on the same machine as e-mail software 116, as shown by the dotted-line enclosure 125. For example, receipt store 124 might be implemented as an application that resides on the same computer as an e-mail client. As another example, receipt store 124 could be implemented as a service (e.g., a cloud computing service) that is accessed through a network. Such a receipt store 124 could be provided by a particular entity that engages in transactions with customers (e.g., transacting entity 106), or could be provided by a third-party entity that exists entirely or primarily to facilitate transactions between other parties (e.g., eBay). One receipt store is shown in FIG. 1, although there could be plural receipt stores to which receipts, and/or the data extracted from receipts, could be sent. Customer 102 may subscribe to a particular receipt store 124 in order to have that receipt store handle receipts on behalf of the customer. The foregoing are some examples of how receipt store 124 could be provided, although receipt store 124 could be provided in any manner.

The sending of receipt 114 to receipt store 124 could be handled using any techniques or mechanisms. For example, receipt processing component 118 could, upon identifying a piece of mail as containing a receipt, extract information from the receipt and forward the extracted information to receipt store 124. Or, as another example, receipt processing component 118 could forward the e-mail that contains the receipt to receipt store 124 (or could instruct e-mail software 116 to forward the receipt). Once the e-mail is at receipt store 124, it could be stored in receipt store 124 in its original form. Or, as another example, software at receipt store 124 could extract the relevant information from the e-mail and could store the extracted information in receipt store 124.

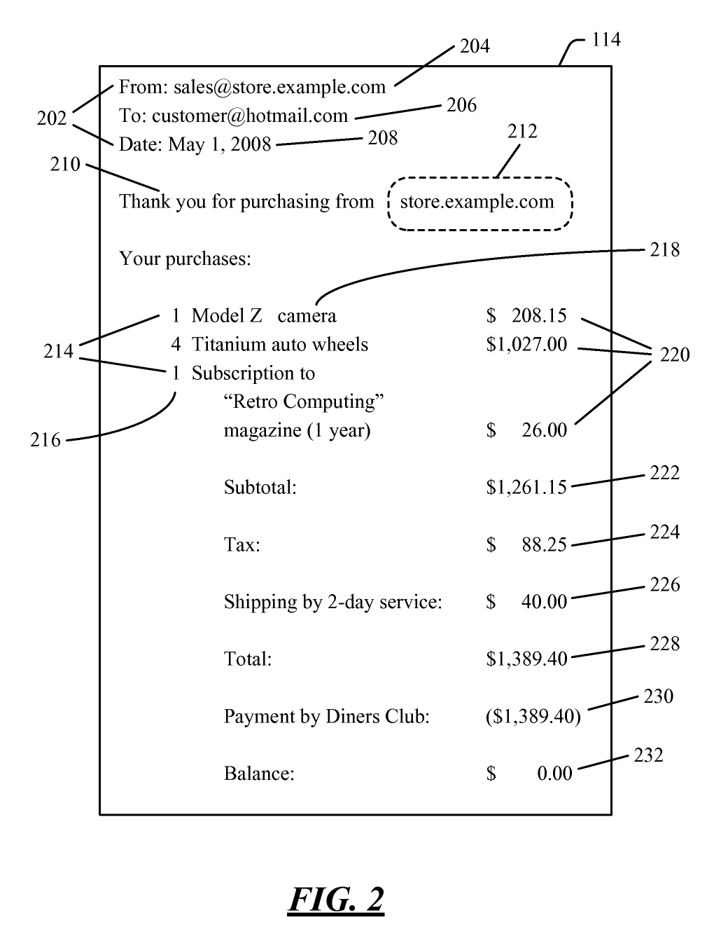

As noted above, receipt 114 could be delivered in the form of an e-mail, and could be recognized as a receipt by receipt processing component 118. FIG. 2 shows example detail of receipt 114 that could be sent by e-mail and that could be recognized as a receipt by an appropriate component.

In FIG. 2, receipt 114 is shown, by way of example, as an e-mail message. Receipt 114 comprises an e-mail header 202 showing the sender 204 and recipient 206 of the receipt, as well as a date 208. Receipt 114 may also have an introductory message 210. Introductory message 210 may comprise a name 212 of the transacting entity that issued the receipt, which in this case is “store.example.com”. Receipt 114 may also comprise an itemized list 214 of purchases. (In the example of FIG. 2, receipt 114 is for a retail purchase, although, as noted above, receipt 114 could be for any type of transaction, such as a lease, rental, travel reservation, charitable deduction, etc. The subject matter described herein is not limited to receipts for any particular type of transaction.) Itemized list 214 may, for example, comprise quantities 216 of items purchased, descriptions 218 of the items purchased, and the amounts 220 for which each item in the list was purchased. Receipt 114 may also comprise information such as a subtotal 222 of the amounts for which the items were purchased, tax 224, shipping charges 226. The receipt could also include shipping information, warranty information, marketing information such as advertisements or coupons, or any other item or information. These amounts may be added together and reflected in a total 228. Receipt 114 may also indicate an amount/method of payment 230, and a balance 232 that is left on account after payment.

As can be seen in FIG. 2, the e-mail in which receipt 114 is contained may comprise certain information from which it could be inferred that the e-mail contains a receipt. For example, the sender 204 (“sales@store.example.com”) might be generally known as a sender of receipts. The name 212 of the transacting entity that issued the receipt could also be known as an issuer of receipts. Words such as “subtotal”, “tax”, “shipping”, “total”, “balance”, etc. might—either alone or in combination—suggest that the content of the e-mail is a receipt. Features of the e-mail, such as the concentration of dollar amounts, might also suggest that the e-mail is a receipt. Any of these words or features could be used to identify the e-mail as a receipt. For example, certain features of receipt processing component 118 (shown in FIG. 1), such as receipt parser 122 (also shown in FIG. 1) could use these words or features to identify an e-mail as containing a receipt and to extract structured information from the receipt. For example, receipt processing component 118 might extract the specific items purchased and their prices from the receipt, and might represent that information in a structured way so that a structured version of the information could be stored in receipt store 124 (shown in FIG. 1).

As noted above, an issuer of receipts could provide code and/or data that would assist receipt processing component 118 in recognizing the receipt. For example, the transacting entity (“store.example.com”) might issue receipts in a particular format, and could provide a template that could help receipt processing component 118 to identify e-mails containing receipts from that transacting entity, and that could also help receipt processing component 118 to extract structured information from the receipt. Or, such a template could be provided by a different entity.

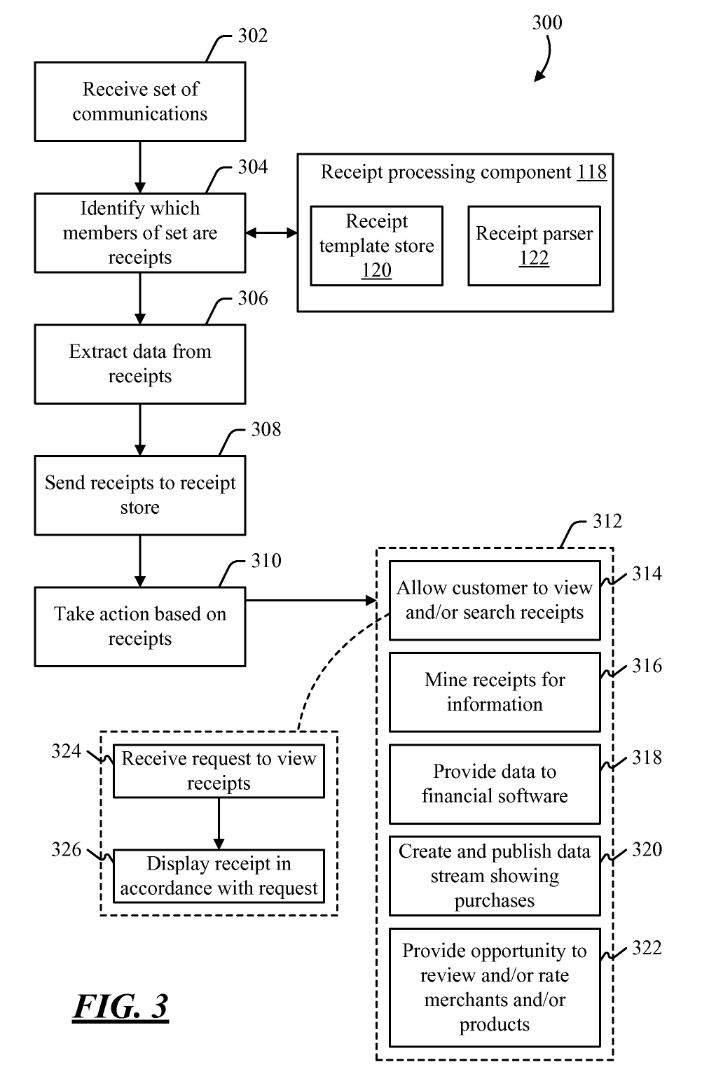

FIG. 3 shows an example process 300 in which receipts may be received, and in which the received receipts may be sent to a receipt store. Before turning to a description of FIG. 3, it is noted that the process in that figure is described, by way of example, with reference to components shown in FIGS. 1 and 2, although this process may be carried out in any system and is not limited to the scenarios shown in FIGS. 1 and 2. Additionally, the flow diagram in FIG. 3 shows an example in which stages of a process are carried out in a particular order, as indicated by the lines connecting the blocks, but the various stages shown in this diagram can be performed in any order, or in any combination or sub-combination.

At 302, a set of one or more communications are received. The communications may take the form of e-mails, SMS messages, IMs, or any other form. At 304, those communications that contain receipts are identified. For example, the location at which the communications are received could be an inbox that a customer uses to receive mail (e.g., an e-mail inbox, an SMS inbox, etc.), and the items that come to the inbox could contain both correspondence and receipts. Receipt processing component 118 could evaluate the incoming communications (e.g., communications that are arriving at an e-mail inbox, an SMS inbox, etc.) to determine which of the incoming communications are receipts. Receipt processing component 118 could make this determination using receipt template store 120 or receipt parser 122, or using any other mechanism. Receipt processing component 118 could also extract data from the receipt (at 306). For example, individual fields of data, such as the various data shown in FIG. 2 (e.g., specific items purchased, prices paid for those items, total amount of purchase, shipping method chosen, etc.) could be extracted from the receipt.

Based on a determination of which communications contain receipts, those communications that have been identified as receipts are sent to a receipt store (at 308). At 310, an action may be taken based on the receipts in the receipt store. Action could be taken on receipts in “real time” (e.g., when the receipts are received), or action could be taken on receipts at some time after they have been received. Some examples of tangible actions 312 are shown.

Among the example actions 312, one such action is to allow a customer to view and/or search receipts (block 314). In general, a receipt store could receive a request to view receipts (at 324), and the system could then display receipts in accordance with the request (at 326). Examples of 324 and 326 include: A customer might log on to a receipt store and ask to see all of the customer's receipts. Or, as another example, the customer could enter a query to view some subset of the customer's receipts that satisfy some search criteria (e.g., all receipts from Amazon.com, all receipts issued in January 2008, all receipts for more than $100, all receipts for charitable donations, etc.), and the customer could be shown those receipts that are responsive to the query.

Another example action is to mine information from the receipts in the store (block 316). For example, the receipts in the store could be evaluated to determine what type of products a given customer likes to purchase, how much money the customer spends in a month, what types of shipping options the customer normally uses, etc. The information could be mined from the receipts for a particular customer. However, the receipt store might store receipts for a plurality of customer, and information could be mined from receipts associated with many different customers. For example, the receipts issued to many customers by a particular merchant could be evaluated to assess whether that merchant's sales are up or down in a particular month, whether a particular advertising campaign is effective, or to assess any other aspect of business that may be gleaned from receipts. The information mined from receipts could be used in any manner. For example, if the receipts suggest that a customer frequently purchases computer equipment, then targeted advertisements or coupons relating to computer equipment could be sent to that customer. As another example, the customer's interest in computer equipment (as mined from that customer's receipts) could be used to disambiguate information—e.g., that information could be used to determine that when the customer types “apple” he is likely to mean the computer and not the fruit.

Another example action is to provide data from the receipts to financial software (block 318). For example, information from receipts in the receipt store could be collected and could be put into a format that is usable by personal or business accounting software. The information in such format could be provided to such accounting software in order to track expenses and/or charitable contributions, create records to be used in tax preparation, etc.

Another example action is to create a data stream showing a customer's purchases or other transactions (block 320). For example, a customer might want to allow other users (e.g., friends, business associates, etc.) to learn of his or her transactions, and could make this information available in the form of a feed, such as a Really Simple Syndication (RSS) free, an Atom feed, etc. A receipt store could provide a service that generates and publishes such feeds based on the customer's receipts in the receipt store.

A further example of an action is to provide a customer with an opportunity to review and/or rate merchants and/or products (block 322). For example, when a customer receives a receipt from a particular merchant for a particular product, this fact could be used as an impetus to offer the customer the chance to review the merchant (e.g., “Rate your buying experience with XYZ Store on a scale of one to ten”) or to review the product (e.g., a month after purchasing a new lawnmower on-line, a customer could be send a survey question such as “Rate the evenness of your new mower's cut from one to five stars”).

It is noted that actions 312 may include actions that are initiated by a customer, or by any other entity. For example, viewing a particular customer's receipts (at block 314) is an action that might be initiated by the customer to whom the receipts are issued. By contrast, mining information from receipts (at block 316) is an action that might be initiated by a business entity that wants to track one or more customers' purchase habits. Actions 312 could be performed and/or initiated by any entity.

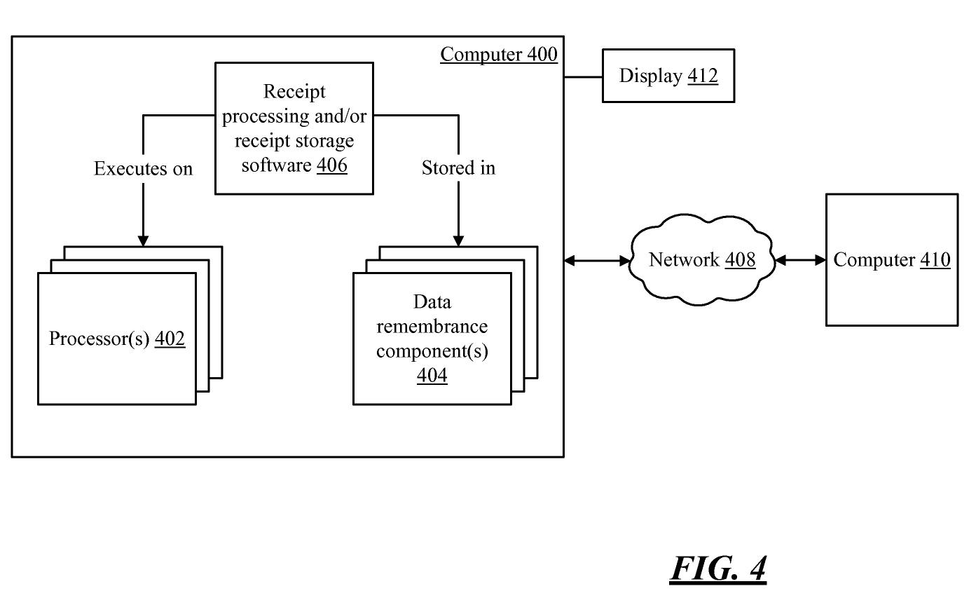

FIG. 4 shows an example environment in which aspects of the subject matter described herein may be deployed.

Computer 400 includes one or more processors 402 and one or more data remembrance components 404. Processor(s) 402 are typically microprocessors, such as those found in a personal desktop or laptop computer, a server, a handheld computer, or another kind of computing device. Data remembrance component(s) 404 are components that are capable of storing data for either the short or long term. Examples of data remembrance component(s) 404 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 400 may comprise, or be associated with, display 412, which may be a cathode ray tube (CRT) monitor, a liquid crystal display (LCD) monitor, or any other type of monitor.

Software may be stored in the data remembrance component(s) 404, and may execute on the one or more processor(s) 402. An example of such software is receipt processing and/or receipt storage software 406, which may implement some or all of the functionality described above in connection with FIGS. 1-3, although any type of software could be used. Software 406 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 4, although the subject matter described herein is not limited to this example.

The subject matter described herein can be implemented as software that is stored in one or more of the data remembrance component(s) 404 and that executes on one or more of the processor(s) 402. As another example, the subject matter can be implemented as software having instructions to perform one or more acts of a method, where the instructions are stored on one or more computer-readable storage media. The instructions to perform the acts could be stored on one medium, or could be spread out across plural media, so that the instructions might appear collectively on the one or more computer-readable storage media, regardless of whether all of the instructions happen to be on the same medium. In one example environment, computer 400 may be communicatively connected to one or more other devices through network 408. Computer 410, which may be similar in structure to computer 400, is an example of a device that can be connected to computer 400, although other types of devices may also be so connected. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to perform a method of handling a receipt, the method comprising:
receiving a set of communications at a correspondence inbox, there being both items of correspondence and receipts among said set of communications;
identifying one of said communications as containing said receipt;
based on said identifying, sending said receipt to a receipt store; and
taking an action based on receipts stored in said receipt store, said receipt being among the receipts stored in said receipt store.

2. The one or more computer-readable storage media of claim 1, wherein the method further comprises:
receiving, from a customer whose transaction generated said receipt, a request to view some or all of said receipts,
and wherein said action comprises:
displaying or communicating, to said customer, those ones of said receipts that are responsive to said request.

3. The one or more computer-readable storage media of claim 1, wherein said action comprises:
mining said receipts stored in said receipt store to obtain information about whether a merchant's sales are up or down in a given time period, or whether an advertising campaign of said merchant has been effective.

4. The one or more computer-readable storage media of claim 3, wherein said receipt store handles receipts for a plurality of customers, and wherein said mining of said receipts comprises:
taking into account receipts of more than one of said customers.

5. The one or more computer-readable storage media of claim 1, wherein said action comprises:
communicating or storing data from said receipt in an accounting program format.

6. The one or more computer-readable storage media of claim 1, wherein said action comprises:
publishing, as a feed, purchases represented by said receipts.

7. The one or more computer-readable storage media of claim 1, wherein said action comprises:
identifying a merchant among said receipts; and
providing, to a customer whose transaction generated said receipt, a survey to rate said merchant.

8. The one or more computer-readable storage media of claim 1, wherein said action comprises:
identifying a product listed among said receipts; and
providing, to a customer whose transaction generated said receipt, a survey to rate said product.

9. A system to handle receipts, the system comprising:
a processor;
a data remembrance component;
an e-mail program that executes on said processor, that receives a set of communications directed to a customer, the set of communications comprising items of correspondence and receipts;
a receipt-processing component that executes on said processor, that communicates with said e-mail program to evaluate said communications, that identifies one of said communications as containing a receipt, that sends the receipt to a receipt store; and
a template that is stored in said data remembrance component and that is descriptive of a class of receipts, said template being used by said receipt-processing component to identify said receipt from among said communications.

10. The system of claim 9, further comprising:
a receipt parser that recognizes content in said communications that is indicative of said content being a receipt.

11. The system of claim 9, wherein said e-mail program comprises a server that receives mail on behalf of said customer, and wherein said receipt processing components comprises a plug-in or add-on to said e-mail program or is an integral part of said e-mail program.

12. The system of claim 9, wherein said e-mail program comprises a client application that receives e-mail to be viewed by said customer, and wherein said receipt processing component comprises a plug-in or add-on to said client application or is an integral part of said client application.

13. The system of claim 9, wherein said receipt processing component provides content based on said receipt in an accounting program format.

14. A method of handling receipts, the method comprising:
using a receipt processing component to identify a receipt among a set of communications that are sent to an address, said set of communications comprising both receipts and correspondence;
sending said receipt to a receipt store;
receiving a request from a customer to view said receipt; and
displaying said receipt to said customer in accordance with said request.

15. The method of claim 14, wherein said request comprises a query, said receipt being responsive to said query, and wherein the method further comprises:
displaying receipts responsive to said query, including said receipt, wherein said receipt comprises shipping information, warranty information, marketing information, advertising information, or a coupon.

16. The method of claim 14, wherein said address is associated with said customer and comprises either an e-mail address, an instant messaging address, or a short message service address.

17. The method of claim 14, wherein said using of said receipt processing component comprises:
using a receipt parser to identify content in said set of communications that is indicative of receipts; and
using said receipt parser to extract fields from said receipt.

18. The method of claim 14, wherein said using of said receipt processing component comprises:
comparing said set of communications to a template to determine a level of similarity of communications in said set to said template; and
identifying said receipt based on an item that contains said receipt having a level of similarity to said template that exceeds a threshold.

19. The method of claim 14, further comprising:
mining said receipts stored in said receipt store to obtain information.

20. The method of claim 14, further comprising:
publishing, as a feed, purchases represented by said receipts.
